(19) United States
(12) Patent Application Publication
(10) Pub. No.: US 2026/0158879 A1
(43) Pub. Date: Jun. 11, 2026

(54) MAGNETIC MOUNTING SYSTEM FOR WINDSHIELD ON LOW-SPEED VEHICLES

(71) Applicant: Fitz WOODROW, Charlottesville, VA (US)

(72) Inventor: Fitz WOODROW, Charlottesville, VA (US)

(21) Appl. No.: 19/414,899

(22) Filed: Dec. 10, 2025

Related U.S. Application Data
(60) Provisional application No. 63/730,559, filed on Dec. 11, 2024.

(51) Int. Cl. B60J 1/00; B60J 1/02; B60J 1/06

(52) U.S. Cl. CPC B60J 1/006; B60J 1/025; B60J 1/06

(57) ABSTRACT

Provided is a magnetic mounting system that securely attaches a windshield to a low-speed vehicle. The magnetic mounting system can be independent of other fastening methods to secure the windshield to the infrastructure of a low-speed transport vehicle. The magnetic mounting system can also comprise grip strips, grip tape, or grip spray to further secure the windshield from slippage.

### CROSS-REFERENCE TO RELATED APPLICATIONS

The present application claims priority to U.S. provisional patent application 63/730,559 filed on Dec. 11, 2024, the disclosure of which is hereby incorporated by reference in its entirety.

### BACKGROUND

There are several types of low-speed vehicles, which are typically intended for other than highway use. Golf cars are a popular low speed vehicle. A Polaris Ranger is another example of a low-speed vehicle. Specifically, golf cars are defined under ANSI/NGCMA Z 130.1 “as a vehicle used to convey a person or persons and equipment to play the game of golf in an area designated as a golf course”.

The first golf car was invented in 1932. Since then, many patented improvements have been made to these low-speed vehicles. The first windshield was clear and fixed, adding a safety component by blocking the driver and passenger from wind, rain, and debris. Most often, windshields are currently formed of acrylic or polycarbonate, with acrylic being the most common. More recent versions of a windshield are a transparent folding windshield where a portion of the windshield is fixed to the front struts and is hinged to allow either the upper portion of the windshield or lower portion of the windshield to fold over the fixed portion.

U.S. Pat. Nos. 10,493,825, 10,596,882, and US application 2025/0042229, by Fitz Woodrow, incorporated herein in their entirety, disclose a design wherein the low-speed vehicle windshield is configured to fold from the bottom up, providing physical protection from debris and errant golf balls, while providing air flow when in use. The cited patents envisioned adding films to the outside or inside of the windshield to improve protection to the passengers. Such an innovation is limited in the ability to retrofit existing low-speed vehicles, including golf cars, as each brand and model will have unique tooling and unique fastener locations.

As is common in many industries, modification to designs that require tooling changes in an existing product is cost prohibitive. The current invention overcomes this roadblock by providing a magnetic mounting system that is independent of existing windshield tooling and mounting provisions.

### SUMMARY

The objective of this invention is to provide a magnetic mounting system that securely attaches a windshield to a low-speed vehicle. An additional objective is to have a magnetic mounting system that is independent of other fastening methods of a windshield to the infrastructure of a low-speed transport vehicle.

Several versions of this invention are envisioned, including, but not limited to, windshields for any low-speed vehicle, fully fixed (non-folding) windshields, fold down windshields, fold up windshields, windshields with folding side vents, wherein the magnets are mounted to the low-speed vehicle transport infrastructure with strike plates present on the windshield, and/or magnets mounted to the windshield, wherein the magnetic mounting system also incorporates mechanical fasteners between the windshield and low-speed vehicle, or wherein the magnetic mounting system is fully independent of mechanical fasteners, such as screws, bolts, clips, clamps, and brackets, between the windshield and the low-speed transport vehicle infrastructure.

In one embodiment, a grip strip, grip tape, or grip spray is used to further secure attachment of the windshield. It has been found that the use of the grip strip, tape, or spray enhances attachment and prevents slippage of the windshield vertically.

Although many versions are envisioned and considered encompassed by this invention, the invention is generally described while referring to a golf car and a windshield that folds up, wherein the magnets are mounted to the windshield, which attach to the golf car struts, or a magnetic infrastructure of an alternate low-speed vehicle, and is independent of mechanical fasteners between the windshield and golf car, or alternate low-speed vehicle. The present mounting system can work in conjunction with a complementary windshield.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a side view of a golf car with a front windshield mounted with the magnetic mounting system of the current invention, utilizing two channel magnets per side of the windshield, i.e. a four-piece system.

FIG. 2 is the side view of a magnetic mounting system utilizing one channel magnet per side of the windshield, i.e., a two-piece system.

FIG. 3 depicts a two-piece fold-up windshield using the present magnetic mounting system.

FIG. 4 depicts a two-piece fold-up windshield with one channel magnet per side.

FIG. 5 depicts a two-piece fold-down windshield using two channel magnets per side.

FIG. 6 depicts a two-piece fold-down windshield with one channel magnet per side.

FIG. 7 depicts a one-piece windshield with two channel magnets per side.

FIG. 8 depicts a one-piece windshield with one channel magnet per side.

FIG. 9 shows a bottom view of the channel magnet, the neodymium magnets and the bottom of the threaded female stud, and a side view of the channel magnet and the threaded female stud.

FIG. 10 shows a top view of the channel magnet and the top of the threaded female stud.

FIG. 11 shows a bottom view and a side view of the magnet inside the protective cover used to protect the magnet during shipping and to reduce the magnetic force while marking the proper place on the upper front strut for final install.

FIG. 12 shows the top view of the magnet inside the protective cover used to protect the magnet during shipping and to reduce the magnetic force while marking the proper place on the upper front strut for final install.

### DETAILED DESCRIPTION

The present mounting system is for windshields utilized by golf cars and low-speed transport vehicles. The magnetic mounting system eliminates the need for mechanical fasteners and any new tooling required in order to mount the windshield to golf cars and low-speed transport vehicles. New innovations in windshields may be hard to implement as the innovations require expensive, new tooling on established product manufacturing lines. The present windshield mounting system overcomes the difficulty of modifying tooling for windshields for golf cars and low speed transport vehicles as windshields are securely mounted to the low-speed transport vehicle infrastructure utilizing magnets.

When the term windshield is used within the specification and claims, the term refers to a low-speed vehicle windshield, unless otherwise specified.

While any magnetic material can be used in the present system, the preferred magnetic materials are those of the rare-earth type, especially neodymium rare-earth magnets, which are known for their superior strength. The magnetic material may be coated with a thin layer of corrosion resistant material, including metal such as nickel, plastic, or resin such as epoxy. Such magnetic material is commercially available. The current invention is not limited to magnetic material currently available as any magnetic material of sufficient strength can be used.

Generally, the magnetic material is formed or placed in a housing, preferably a channel, commonly made from steel, stainless steel, aluminum, anodized aluminum or powder coated aluminum. Alternate shaped housing would include disc shaped or any multi-sided housing. Other materials, including other metals, coated metals, plastic, resin, carbon, or a combination of these materials may be used for the housing. Steel or stainless steel helps retention of the magnetic material within the housing as, unlike aluminum, the magnetic material is attracted to the steel or stainless steel. The magnetic material can also be bonded within the housing. In one embodiment, the housing is a channel and the magnet is referred to as a channel magnet.

In one embodiment the channel magnet, or alternate shaped housing with magnetic material, is bonded to a windshield for a low-speed vehicle. In an alternate embodiment, the channel has one or more openings per channel for a mechanical fastener, optionally a screw with an optional flat head, a strike plate with an optional countersunk hole, a rubber washer, and nut, that fastens the channel magnet to the windshield. In another embodiment, the channel has one or more openings per channel that include an integral or attached nut and/or locking nut, i.e. a female threaded stud connector, for receiving a mechanical fastener such as a screw or bolt. The attachment of the channel magnet may utilize only one attachment method or any of the attachment methods in combination.

Although any number of channel magnets of any length and width can be used, one embodiment uses two channel magnets per side, upper left and right of the windshield and lower left and right of the windshield or one channel magnet per side, down the length of each side of the windshield. The channels are preferably in a range of 0.4 inch to 1.5 inch wide and in a range of 0.125 to 0.5 inch in depth. The preferred length and width do not interfere with the viewing area of the windshield.

Reference will now be made in detail to exemplary aspects of the present disclosure that are illustrated in the accompanying drawings. Wherever possible, the same reference numbers will be used throughout the drawings to refer to the same or like parts.

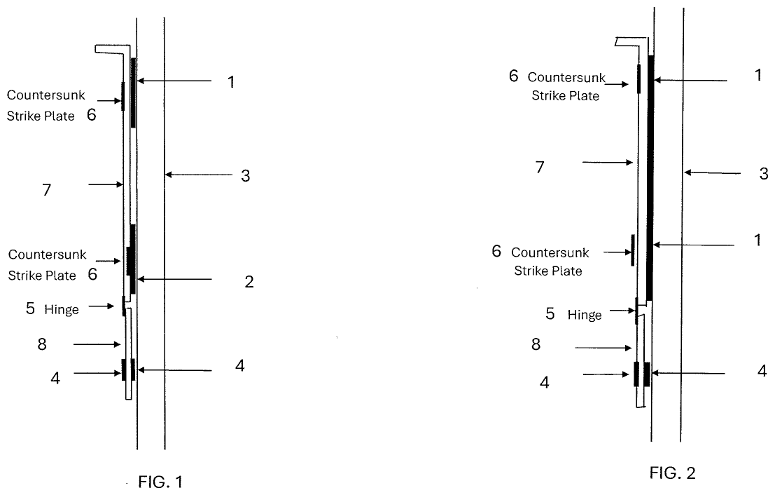

FIG. 1 shows a four-piece magnetic mounting system, i.e., two magnets on each side of the windshield, with a channel magnet (1), comprising the channel housing and the neodymium magnetic material mounted to a windshield (2), the windshield attached to the struts (3) of a golf car. A hinge in the windshield divides the windshield (2) into an upper portion (7) and a lower portion (8). Strike plates (6) are also present in the system.

FIG. 2 is a side view wherein the windshield (2) has one channel magnet (1) per side, i.e., a two-piece magnetic mounting system. Each channel magnet has at least one opening for a fastener, a plate (or washer), and preferably, a threaded female stud integral or attached to the channel. Although a single fastener opening per channel is envisioned, another embodiment comprises at least two openings per channel to reduce the possibility of rotation. Within the channel magnet, the magnetic material may fill the entire channel other than openings for fasteners, or alternatively, the magnetic material may be divided into two or more sections. The hinge (5) dividing the windshield into an upper portion (7) and a lower portion (8), and the strike plates (6) are also present.

In one embodiment, the windshield folds up to allow air flow to the passengers. The windshield will fold up around the hinge 5, which is shown in both FIGS. 1 and 2. A magnetic latching system (4) is also shown in FIGS. 1 and 2 and is used to maintain the windshield in the folded position. The latching system is described in US 2025/0042229, which is incorporated herein by reference in its entirety. The magnetic latching system comprises pot magnets (4) which have a male and female magnet connected together, e.g., threaded by a screw. The male and female magnets are on opposite sides of a windshield. The present mounting system incorporates and works in conjunction with the latching system. A strike plate (6), optionally countersunk, is mounted on a fixed portion of the windshield and is used to connect to the magnets in the latching system. The strike plate can be fastened to the windshield independently, or in one embodiment, utilizes the same fastener that attaches the channel magnet to the windshield. A second latching system and strike plate is provided on the second side of the windshield. A third and fourth strike plate can be added to the windshield, on the fixed portion, for symmetry, adding to the cosmetic appeal of the magnetic system. Each of the strike plates can be mounted to the windshield independently or utilize a fastener that is also securing the channel magnet to the windshield. A washer placed between the strike plate and windshield is optional to reduce noise.

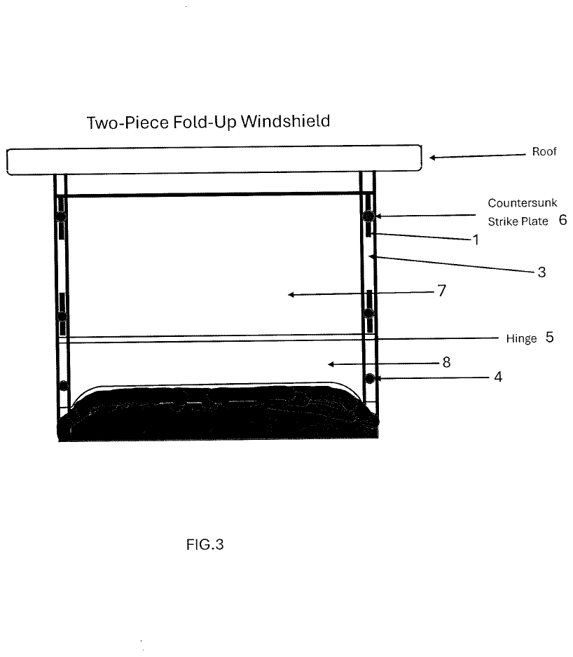

FIG. 3 depicts a two-piece fold-up windshield. It utilizes a 4-piece magnet system, one is in the upper left side of the upper section (7) of the windshield, one (1) is in the upper right side of the upper section (7) of the windshield, one is in the bottom left side of the upper section (7) of the windshield, and one is in the lower right side of the upper section (7) of the windshield. The 4-piece magnet system attaches to the upper front strut (3) of the vehicle. The lower section of the windshield (8) has 2 magnets, pot-magnets (4) that attach to the upper front strut (3) to hold the windshield down in the no airflow mode or closed position. This is part of the magnetic latching system. When airflow or the open mode is desired, the lower section rotates upward, and the magnets of the latching system attach to the strike plates on the upper section of the windshield.

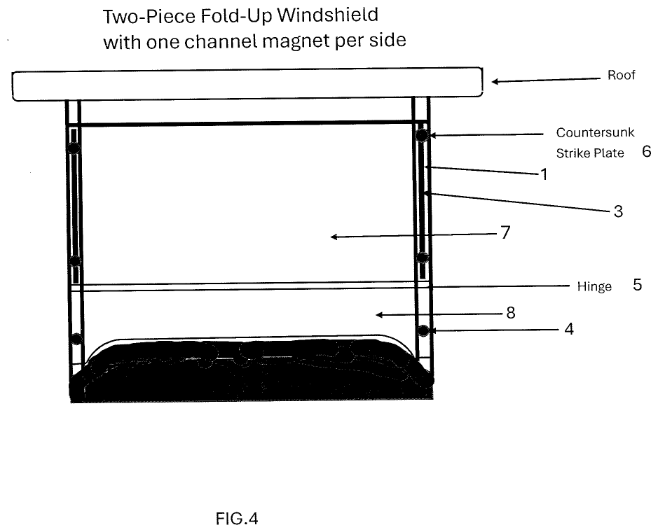

FIG. 4 depicts a two-piece fold-up windshield with one channel magnet (1) per side. It utilizes 2-long magnets, approximately the length of the upper section (7) of the windshield, one is in the left side of the upper section of the windshield, one is on the right side of the of the windshield. The 2 magnets attach to the upper front strut (3) of the vehicle. The lower section of the windshield (8) has 2 magnets, pot-magnets (4) that attach to the upper front strut to hold the windshield down in the no airflow mode or closed position. When airflow or the open mode is desired, the lower section rotates upward, and the magnets attach to the strike plates (6), generally the lower strike plates.

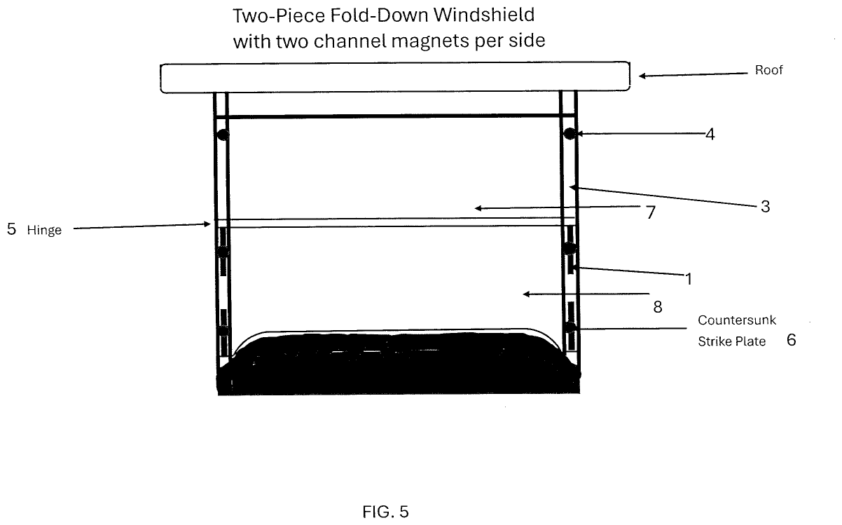

FIG. 5 depicts a two-piece fold-down windshield. It utilizes a 4-piece magnet system, one is in the upper left side of the lower section (8) of the windshield, one is in the upper right side of the lower section of the windshield, one is in the bottom left of the lower side of the windshield, and one is in the lower right side of the lower windshield. The 4-piece magnet system attaches to the upper front strut (3) of the vehicle. The upper section of the windshield (7) has a 2-magnet latching system with pot-magnets (4) that attach to the upper front strut (3) to hold the windshield in the no airflow mode or closed position. When airflow or the open mode is desired, the upper section rotates downward, and the magnets attach to the strike plates (6).

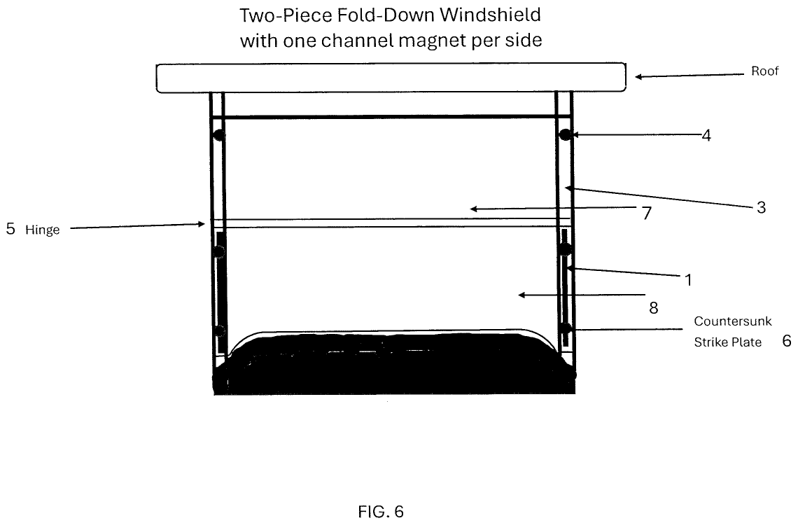

FIG. 6 depicts a two-piece fold-down windshield (10) with one channel magnet (1) per side. It utilizes 2 long magnets, one is in the left side of the lower section of the windshield, one is on the right side of the lower section of the windshield. The 2-piece magnet system attaches to the upper front strut of the vehicle. The upper section (7) of the windshield has a 2-piece magnet latching system comprising pot-magnets (4) that attach to the upper front strut (3) to hold the windshield closed in the no airflow mode. When airflow or the open mode is desired, the upper section (7) rotates downward, and the magnets (4) attach to the strike plates (6).

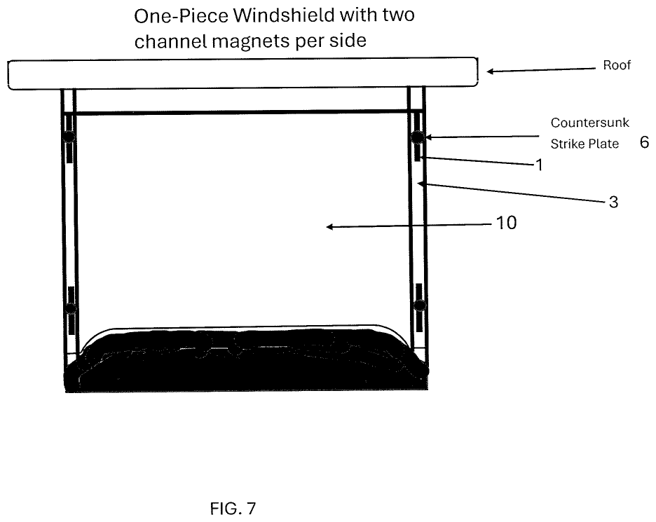

FIG. 7 depicts a one-piece windshield (10) with two channel magnets (1) per side. It utilizes 4-piece magnet system, one is in the upper left side of the upper section of the windshield, one is in the upper right side of the upper section of the windshield, one is in the bottom left of the upper side of the windshield, and one is in the lower right side of the upper windshield. The 4 magnets attach to the upper front strut (3) of the vehicle.

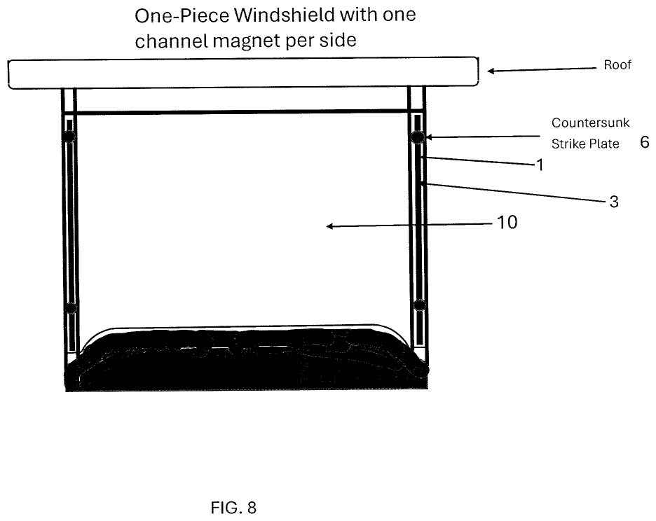

FIG. 8 depicts a one-piece windshield (10) with one channel magnet (1) per side. It utilizes 2-long magnets, approximately the length of the windshield, one is in the left side of the windshield, one is on the right side of the of the windshield. The 2-magnets attach to the upper front strut (3) of the vehicle.

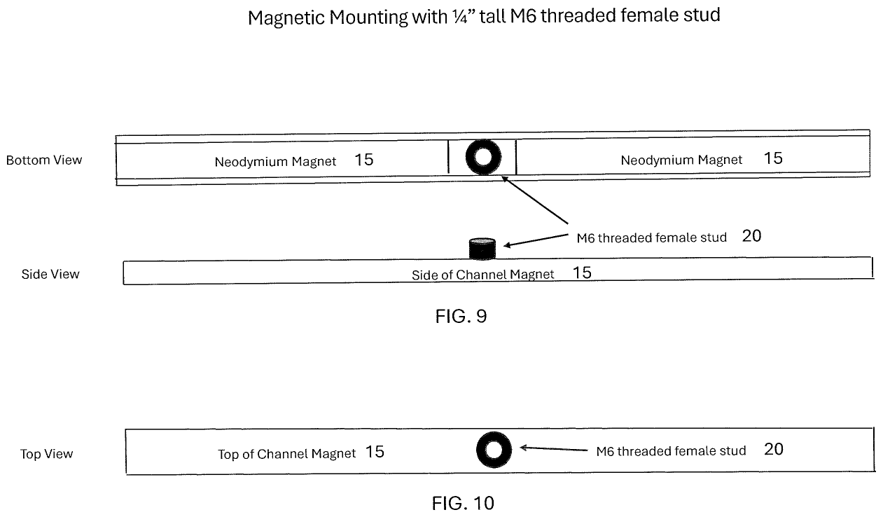

FIG. 9 shows a bottom view of a channel, the neodymium magnets (15) and the bottom of the threaded female stud (20), which secures the magnet in the channel. FIG. 9 also shows a side view of the channel magnet (15) and the threaded female stud (20).

FIG. 10 shows a top view of the channel magnet (15) and the top of the threaded female stud (20).

In one embodiment, the complimentary windshield will have at least two holes, optionally 0.3125 inches in diameter, drilled 0.2 to 0.75 inch, preferably 0.5″, from the sides and 1-15 inches, preferably 1-6 inches, from top and bottom of the windshield. The holes of the windshield are aligned with a channel magnet, or alternate shaped magnet, a rubber washer and countersunk steel strike plate, which are fastened together with a threaded screw into a threaded female stud, which may be integral or attached to the housing, or a nut integral to the housing. When the windshield is assembled with the present mounting system, the windshield can be referenced as the MagMount™ Windshield.

The magnetic force of the channel magnets is optimized so that the windshield assembled with the present magnetic mounting system does not slip during use. The present mounting system can be optimized wherein the magnetic force is less when an additional mechanical means is used to prevent slipping, such as grip strips, grip spray, blocks, or any other type of additional fastening mechanism. One embodiment is wherein the present mounting system does not require any additional attachment method to the low-speed transport vehicle infrastructure.

In another embodiment, grip strips are used as an additional attachment mechanism (which can also be considered as non-slip mechanisms). A non-limiting example is grip strip material sold by CatTounge of Utah, wherein one surface of the grip strip is inclusive of adhesive and the opposite surface is a gripping technology. The strips are sufficiently thin to not reduce the effective force of the magnet. The strips can be essentially a tape if necessary. The adhesive side is used to mount the grip strip to the magnet, while the grip technology surface contacts the golf car strut. A reversal, where the grip strip is adhesively adhered to the golf car strut and the grip technology surface contacts the magnet, is a modification of the embodiment. An alternate embodiment is where the grip strip has gripping technology on both surfaces of the strip. The grip strips can be the same length of the magnet or any partial length, for example portions at the top, center and/or bottom of the magnet. A grip spray is a modification wherein the grip spray coating would be sufficiently thin to not reduce the effective force of the magnet. The grip spray would be applied to preferably the magnet, alternately to the strut, or a combination of the magnet and strut. The spray is dried or cured prior to mounting the windshield to the golf car strut. In addition, fasteners securing the housing to the windshield can be reduced by the use of grip strips, grip tape, or grip spray between the housing and the windshield to prevent twisting of the magnets. The adhesive side of the grip strips may interface with the housing or the windshield. The grip strips may be removed and replaced at any time, as well as the grip spray may be refreshed at any time.

It has been found that the use of the grip strip, grip tape, or grip spray secures the attachment of the windshield to the infrastructure of the low-speed transport vehicle so the windshield does not slip vertically. The magnets do secure the windshield from being pulled from the vehicle, but slippage downward can occur at times if the magnetic force is not sufficient. The use of the grip strip, grip tape, or grip spray has been found to eliminate vertical slippage. And this is achieved without intervening with the magnetic force.

In another embodiment, blocks are utilized, which would include a clip or clamp. A simple C-shaped clip or clamp, or alternate shape, of any material, placed below the magnet sufficiently reduces any chance of slippage. The preferred clip or clamp material is sufficiently flexible to slip around the strut while exerting a grip force when in place. Typical materials would include, but are not limited to, metal, plastic, rubber type materials, inclusive of synthetic rubbers such as ethylene propylene diene (EPDM). The portion of the clip or block between the strut and windshield is thinner than the magnet. While the preferred clip or block does not use an adhesive or fastener, use of an adhesive or fastener to secure the clip or block to the golf car strut below the magnet is an alternative embodiment.

The magnetic force is controlled by controlling the magnet material and size, inclusive of the length, width, depth, or any combination. By increasing the housing length, width, and/or depth and the associated magnet length, width, and/or depth, the pull force of the window is optimized. A pull force of any amount may be utilized, e.g., from 100 to 1000 pounds of pull force, preferably from 150 to 800 pounds of pull force. For the non-limiting best mode embodiment, a pull force was optimized at 250 to 800 pounds pull force. The optimized pull force was able to hold a windshield weighing 20 pounds or less from slipping during use, and yet one person is able to mount and remove the windshield from the low-speed transport vehicle infrastructure.

While one person is able to mount and remove the present mounted windshield in the present mounting system, methods have been developed to ease installation. One improvement is the use of removable magnet covers. Magnet covers protect the magnets during shipping, storage, and eases positioning of the magnets. Magnet covers may be formed by any method including extrusion, molding, machining, 3D printing or ink-jet printing. Further, magnet covers may be formed of any material, magnetic or non-magnetic, a preferred material being an environmentally friendly, biodegradable material, such as those used in 3D printing, e.g. polylactic acid (PLA) or polyhdroxyalkanoates (PHA). Recycling of the magnet covers is another environmentally friendly embodiment. The magnet covers may be held in place by any temporary means inclusive of magnetic means, form fit means, elasticized edge, and/or ties. In use, the magnet covers prevent a strong bond between the windshield mounting magnets and the golf car struts. The preferred location of the windshield can be marked with the magnet covers in place, the magnet covers are subsequently removed, and the windshield mounted and installed at the previously marked location.

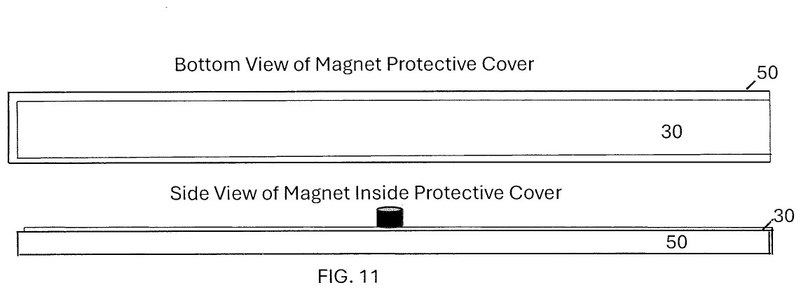

Turning to FIG. 11, the figure shows a bottom view and a side view of the magnet (30) inside a protective cover (50) used to protect the magnet during shipping and to reduce the magnetic force while marking the proper place on the upper front strut for final install.

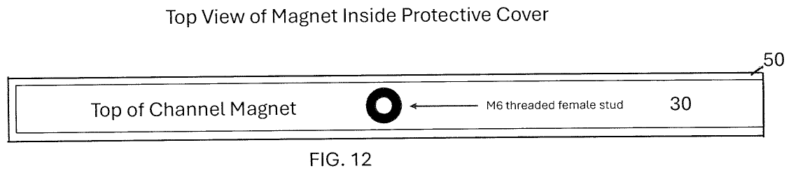

FIG. 12 shows a top view of a magnet (30) inside a protective cover (50) used to protect the magnet during shipping and to reduce the magnetic force while marking the proper place on the upper front strut for final install.

Having described the preferred aspects and implementations of the present disclosure, modification, and equivalents of the disclosed concepts may readily occur to one skilled in the art. However, it is intended that such modifications and equivalents be included within the scope of the claims which are appended hereto.

What is claimed is:

1. A windshield attached to a low-speed transport vehicle by a mounting system that comprises magnets.

2. The windshield of claim 1 attached by a magnetic mounting system, wherein the mounting system is independent of fastening means other than magnets.

3. The windshield of claim 1 attached by a magnetic mounting system, wherein the mounting system further comprises grip strips, grip tape, or grip spray to thereby further secure the windshield attachment to the low-speed transport vehicle and prevent vertical slippage.

4. The windshield of claim 3, wherein grip strips are used to enhance attachment.

5. The windshield of claim 3, wherein grip spray is used to enhance attachment.

6. The windshield of claim 1 attached by a magnetic mounting system, wherein the magnets used in the mounting system had been stored and/or transported in a removable cover.

7. The windshield of claim 1 attached by a magnetic mounting system, which comprises a hinge which separates the windshield into an upper and lower portion.

8. The windshield of claim 7, wherein the upper portion of the windshield folds down over the lower portion of the windshield and is secured in the fold-down position by magnets.

9. The windshield of claim 7, wherein the lower portion of the windshield folds up over the upper portion of the windshield and is secured in the fold-up position by magnets.

10. The windshield of claim 1 attached by a magnetic mounting system, wherein the mounting system comprises 2, 4, or more magnets.

11. The windshield of claim 7, wherein the mounting system comprises 2, 4, or more magnets.

12. A low-speed transport vehicle comprising a windshield which is attached to the low-speed transport vehicle by a magnetic mounting system.

13. The low-speed transport vehicle of claim 12, wherein the magnets in the mounting system are supplemented by additional fastening means.

14. The low-speed transport vehicle of claim 12, wherein the mounting system further comprises grip strips, grip tape, or grip spray to further secure the windshield attachment and prevent vertical slippage of the windshield.

15. The low-speed transport vehicle of claim 10, wherein the windshield comprises a hinge which separates the windshield into an upper portion and a lower portion.

16. The low-speed transport vehicle of claim 15, wherein the upper portion is folded down over the lower portion and is secured by pot magnets.

17. The low-speed transport vehicle of claim 15, wherein the lower portion is folded up over the upper portion and secured by pot magnets.

18. The windshield of claim 1, wherein the windshield is mounted using neodymium rare-earth magnets.

19. The windshield of claim 1, wherein channel magnets comprise the entire length of the windshield.

20. The windshield of claim 7, wherein the windshield is mounted by channel magnets that span the entire length of the upper portion of the windshield.

21. The windshield of claim 7, wherein the windshield is mounted by channel magnets that span the entire length of the lower portion of the windshield.
